(19) United States
(12) Patent Application Publication
(10) Pub. No.: US 2006/0013219 A1
(43) Pub. Date: Jan. 19, 2006

(54) Peer-to-peer data backup and data access tool

(76) Inventors: Brian R. Neilson, Oviedo, FL (US); Sean E. McCandless, Orlando, FL (US); Mark D. Ash, Barcelona (ES)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(21) Appl. No.: 11/171,696

(22) Filed: Jun. 29, 2005

Related U.S. Application Data
(60) Provisional application No. 60/584,057, filed on Jun. 29, 2004.

(51) Int. Cl. H04L 12/56

(52) U.S. Cl. 370/389

(57) ABSTRACT

Methods and systems for performing peer-to-peer backup are provided. According to one embodiment, a P2P backup system includes multiple peers on an IP network forming a P2P network, an edge peer residing behind a firewall, a rendezvous server, a relay server and a P2P backup process running on each of the peers. Each peers may function as a server peer by storing a configurable amount of backup data on behalf of other peers. The rendezvous server is visible to all of the peers and configured to enable the peers to discover other online peers. The relay server is associated with the edge peer and allows communication to/from other of the peers to be initialed with the edge peer. The P2P backup process automatically and securely backs up data of one or more of the peers to one or more remote server peers in accordance with a configurable backup schedule.

This application claims the benefit of Provisional Application No. 60/584,057, filed Jun. 29, 2004, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 312, Inc. 2004-2005.

### BACKGROUND

1. Field

Embodiments of the present invention relate generally to data backup software and peer-to-peer (P2P) networking. More particularly, embodiments of the present invention relate to methods and techniques of automatically backing up user data to one or more remote peer hosts and subsequently allowing access to that data from any compatible client.

2. Description of Related Art

For most non-technical people, backing up a computer is a difficult task. While people generally recognize they should perform periodic backups, in view of the efforts and costs involved in connection with current backup solutions, it is unfortunately not until a computer crashes, a laptop is stolen, or data is otherwise lost that backups become part of a routine.

### BRIEF DESCRIPTION OF THE SEVERAL VIEWS OF THE DRAWINGS

Embodiments of the present invention are illustrated by way of example, and not by way of limitation, in the figures of the accompanying drawings and in which like reference numerals refer to similar elements and in which:

FIG. 1 is an example of a computer system in which one embodiment of the present invention may be implemented.

### SUMMARY

Methods and systems are described for performing peer-to-peer backup, recovery and associated administration and control. According to one embodiment, a peer-to-peer back up system includes multiple peers residing on an Internet Protocol (IP) network and forming a peer-to-peer network, at least one rendezvous server coupled to the IP network, a relay server and a peer-to-peer backup process running on each of the peers. The multiple peers include an edge peer residing behind a firewall. Each of the peers is capable of functioning as a server peer by storing a configurable amount of backup data on behalf of other of the peers. The rendezvous server is visible to all of the peers and is configured to enable the peers to discover other online peers. The relay server is associated with the edge peer and configured to allow the edge peer to communicate with other of the peers and to have communication initiated with the edge peer by other of the peers. The peer-to-peer backup process automatically and securely backs up data of one or more of the peers to one or more remote server peers in accordance with a configurable backup schedule.

Other features of embodiments of the present invention will be apparent from the accompanying drawings and from the detailed description that follows.

### DETAILED DESCRIPTION

Systems and methods are described for peer-to-peer backup. Embodiments of the present invention seek to facilitate automatic backups of computer systems by way of a simple to use and convenient backup system. According to one embodiment of the present invention, selected data on a computer system is automatically backed up to one or more on-line computers (peer to peer). The user may simply select files or folders to protect allowing the backup system to automatically select the appropriate server peers on which to store the backup data. Alternatively, an administrator and/or end user may have some ability to manually select one or more other server peers on which they can lean on for remote storage. New or updated files within the protected folders are automatically protected with no effort on the part of the user. Upon successfully backing up the data, it can then be accessed from any on-line computer where compatible peer-to-peer backup software is installed and configured.

In one embodiment the peer-to-peer backup system may be configured to provide visibility to only users on one or more identified LANs thereby precluding access to users residing outside the identified LANs. Such access restrictions may be enforced by firewalls or via the private network configuration, for example. In one embodiment, a relay is logically positioned outside of the firewalled LAN to enable visibility by all peers that participate in the P2P network.

In the following description, for the purposes of explanation, numerous specific details regarding an existing commercial embodiment are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware and software.

Embodiments of the present invention may be provided as a computer program product which may include a machine-readable medium having stored thereon instructions which may be used to program a computer (or other electronic devices) to perform a process according to the methodologies described herein. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to peer-to-peer backup solutions, the technologies described are equally applicable to various other types or data storage and recovery applications, such as data migration. For example, the user can back his data up then perform a disaster recovery on it to restore it on the new peer, thus migrating the data.

In the attached Appendices, specifically contemplated commercial embodiments and versions of a software implemented peer-to-peer data backup tool referred to as “LeanOnMe,” “LeanBackup,” “PeerSite Backup” and/or “BitVault” are described. Given the many alternative implementations and configurations of various embodiments of the present invention, the examples described in the attached Appendices are not intended to be limiting, but rather illustrative of a particular implementation.

Terminology

Brief definitions of terms and/or phrases used throughout this application are given below.

The terms “connected” or “coupled” and related terms are used in an operational sense and are not necessarily limited to a direct connection or coupling.

The term “group” generally refers to a collection of peers on a private BitVault network in which backup operations are contained within. Groups are sub-groups of the super-group. In one embodiment, a group may be defined based on organizational departments, such as human resources or accounting, user workgroups, or based on project responsibility.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification or an Appendix states a component or feature “may”, “can”, “could”, or “might” be included or have a characteristic, that particular component or feature is not required to be included or have the characteristic.

The term “peer” generally refers to an individual computing node present on a P2P network.

The term “profile” generally refers to a persistent collection of one or more files associated with the user of a peer-to-peer data backup and/or data access program and which customize the program's behavior. According to one embodiment, profiles may be used to store user preferences and configuration information, such as input configurations, style preferences, graphical user interface (GUI) display preferences, etc., to enable users to reconfigure the program quickly when they log on from their home computer or another Internet-connected computer. According to one embodiment, a peer-to-peer data backup and/or data access tool collects identity information from the user, including first name, last name, country, email address, state, zip code, group, computer identification, etc. The identity information is then used to create an identity object, which is then written to an identity XML file. This identity XML file and other XML data, configuration and/or control files containing information, such as a backup schedule indicating days and/or times at which to perform data backup, a maximum amount of local storage which may be used to host backup data of others, whether or not to make a local copy of backup data, identification of trusted peers or groups in which trusted peers reside, etc., may be stored in the form of a Zip file and automatically read during network initialization to set up a P2P environment, such as a JXTA P2P environment. Profiles may be stored locally, transferred to a central server, stored on a removable media and/or manually or electronically transferred to a new peer on which data access needs to be granted. According to one embodiment, a user's identity is managed and protected via the use of a distributed and encrypted user profile. The profile may include all the configuration files used by a user of a peer-to-peer data backup and/or data access tool. The distribution process may occur during the back up operation. For example, each peer that houses backups for a local peer may also act as a repository of the same user's identity. Alternatively, user identities may be stored in a centralized storage location, such as file servers, Lightweight Directory Access Protocol (LDAP) servers, a database, or any network or locally accessible storage area.

The term “quota” generally refers to a maximum amount of local storage that is avaiable on a server peer for use by the peer-to-peer backup program for backing up data of other peers. According to one embodiment, the quota is configurable by an administrator and/or a user of the server peer. For example, a user may set up or change the quota via a GUI quota screen to control how much of a local hard drive other users may use. In one embodiment, users may simply manipulate a slider object and/or enter the desired quota in a text entry box and save the new quota value. So, for example, if a user does not want anyone to use their hard drive space, they could set the quota for their computer system to zero and no backup data would be stored on storage devices associated with their computer system.

The term “relay” generally refers to one or more processes acting as a proxy on behalf of one or more peers to redirect incoming traffic to such one or more peers. According to one embodiment, a relay process is used to act as a proxy for connections behind a firewall thus allowing external connections to be made to peers behind a firewall or Network Address Translation (NAT). In one embodiment, the machine upon which the relay is operating resides outside of the firewalled LAN such that it is visible by all peers that are participating in the P2P network.

The term “rendezvous” generally refers to one or more processes that allow peers within the same P2P network to find one another.

The term “responsive” includes completely or partially responsive.

The term “schedule” generally refers to a mechanism to determine the frequency of backup processing. In one embodiment, an administrator and/or user may schedule how often the peer-to-peer data backup program performs a backup of local data on a particular peer to one or more remote server peers in either relative or absolute mode. For example, in relative mode, the backup process may run every X hours, while in absolute mode the backup process may be configured to run at specific times and/or on specified days.

The term “super group” generally refers to the group to which all sub-groups belong.

The phrase “server peer” generally refers to a peer to which backup data may be directed and stored. According to one embodiment, peer selection is performed automatically by the peer-to-peer backup program with reference to one or more configuration files that (1) identify those of the peers in the same group or the super group that are designated as servers; and (2) indicate the number of peers to which backup data should be distributed across. In one embodiment, an administrator is provided with the ability to control where backup data is stored by designating certain peers as servers. Then, during the backup process, the peer-to-peer backup program may randomly select from the peers designated as servers the appropriate number of peers. According to one embodiment, the server peer allows some centralization of the backup process, so if an administrator wishes he/she can archive the backup repository to permanent media for storage. Also, in one embodiment, sub-groups can have servers in them that are not visible to a peer unless the server and the peer are in the same group or super group. This can be used to isolate sensitive data.

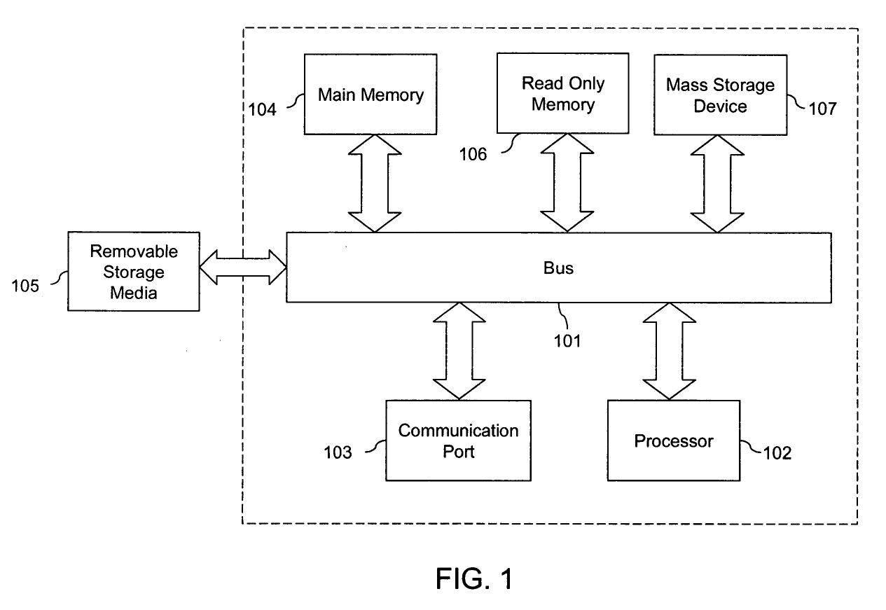

An exemplary machine in the form of a computer system 100 representing an exemplary PC, end-user workstation, server or the like, in which features of the present invention may be implemented will now be described with reference to FIG. 1. In this simplified example, the computer system 100 comprises a bus 101 or other communication means for communicating data and control information, and one or more processors 102, such as Intel® Itanium® or Itanium 1 processors or Sun® UltraSPARC-IIi® processors, coupled with bus 101.

Computer system 100 further comprises a random access memory (RAM) or other dynamic storage device (referred to as main memory 104), coupled to bus 101 for storing information and instructions to be executed by processor(s) 102. Main memory 104 also may be used for storing temporary variables or other intermediate information during execution of instructions by processor(s) 102.

Computer system 100 also comprises a read only memory (ROM) 106 and/or other static storage device coupled to bus 101 for storing static information and instructions for processor(s) 102.

A mass storage device 107, such as a magnetic disk or optical disc and its corresponding drive, may also be coupled to bus 101 for storing instructions and information.

One or more communication ports 103 may also be coupled to bus 101 for supporting network connections and communication of information to/from the computer system 100 by way of a communication network, such as a Local Area Network (LAN), Wide Area Network (WAN), the Internet, or PSTNs, for example. The communication ports 103 may include various combinations of well-known interfaces, such as one or more modems to provide dial up capability, one or more 10/100 Ethernet ports, one or more Gigabit Ethernet ports (fiber and/or copper), or other well-known network interfaces commonly used in internetwork environments. In any event, in this manner, the computer system 100 may be coupled to a number of other network devices, communication devices, clients, and/or servers via a conventional communication network infrastructure.

Optionally, operator and administrative interfaces (not shown), such as a display, keyboard, and a cursor control device, may also be coupled to bus 101 to support direct operator interaction with computer system 100. Other operator and administrative interfaces can be provided through network connections connected through communication ports 103.

Finally, removable storage media 105, such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), Zip disks, or USB memory devices, e.g., thumb drives or flash cards, may be coupled to bus 101 via corresponding drives, ports or slots.

In the foregoing specification and the attached Appendices, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A system comprising:
a plurality of peers residing on an Internet Protocol (IP) network and forming a peer-to-peer network, the plurality of peers, each of the plurality of peers capable of functioning as a server peer by storing a configurable amount of backup data on behalf of other of the plurality of peers;
at least one rendezvous server coupled to the IP network and visible to all of the plurality of peers, the at least one rendezvous server configured to enable the plurality of peers to discover other online peers of the plurality of peers; and
a peer-to-peer backup process running on each of the plurality of peers, the peer-to-peer backup process automatically and securely backing up data of one or more of the plurality of peers to one or more remote server peers of the plurality of peers in accordance with a configurable backup schedule.

2. A method comprising:
discovering a plurality of peers residing on an Internet Protocol (IP) network that are part of a peer-to-peer data backup network, each of the plurality of peers capable of functioning as a server peer by storing a configurable amount of backup data on behalf of other of the plurality of peers;
receiving an indication of selected data files that are desired to be backed up for a particular peer of the peer-to-peer data backup network; and
responsive to a configurable backup schedule, securely and reliably transferring data associated with the selected data files to one or more online peers of the peer-to-peer data backup network that are functioning as server peers.
